(19) United States
(12) Patent Application Publication
(10) Pub. No.: US 2021/0090343 A1
(43) Pub. Date: Mar. 25, 2021

(54) METHOD, AND A SYSTEM FOR DESIGN REVIEWS AND TRAININGS

(71) Applicant: ACTIVA INNOVATIONS SOFTWARE PRIVATE LIMITED, Fremont, CA (US)

(72) Inventors: Mahesh Godi, Fremont, CA (US); Satwik Kommabhatla, Hyderabad (IN)

(73) Assignee: ACTIVA INNOVATIONS SOFTWARE PRIVATE LIMITED

(21) Appl. No.: 17/026,173

(22) Filed: Sep. 19, 2020

(30) Foreign Application Priority Data
Sep. 19, 2019 (IN) 201941037922

(51) Int. Cl. G06T 19/00; G06N 20/00; G06F 3/0481; G06T 17/00

(52) U.S. Cl. CPC G06T 19/006; G06T 17/00; G06F 3/04815; G06N 20/00

(57) ABSTRACT

It is an object of the present invention to address the problems associated with the prior art techniques, and a novel system, apparatus, and a method for providing improved design reviews and user training. This technology opens the door to a range of new applications that have not been possible until now. The present invention revolutionizes training and design reviews with a radically new experience using virtual/augmented reality technique. Using the present invention, multiple users may collaborate remotely and perform design reviews and trainings within the virtual/augmented reality environments.

### CROSS REFERENCE TO RELATED APPLICATION

This application claims priority from Indian Patent Application No. 201941037922 filed on Sep. 19, 2019, titled “A Method, And A System For Design Reviews And Trainings”, herein incorporated by reference in its entirely.

### FIELD OF THE INVENTION

Embodiments of the present invention in general, concern a system, apparatus, and method for providing design reviews and trainings. More particularly, embodiments of the present invention concern to a system, apparatus, and method for providing design reviews and trainings using artificial intelligence and augmented reality/virtual reality devices.

### BACKGROUND OF THE INVENTION

Prior to the widespread advent of the computers, design reviews methods were typically executed using a paper copy of a design, wherein the collaborative review was accomplished by distributing the paper copy of the subject design to the multiple reviewers.

One of such review method is a sequential design review method, wherein the design copy is provided to first reviewer who may make comments over the design copy, and pass the reviewed copy to the next reviewer, and the process is repeated until all the reviewers have made the comments. The output of this design review is a single document containing comments of all reviewers. However, the disadvantage of this method is that it is highly time consuming, especially if the number of reviewers are more. Furthermore, this design review method is highly inefficient as some reviewers, while marking their inputs for improving the design, do not get access to comments made by other reviewers who came after them.

Other type of design review method known in the prior art is concurrent review method, wherein all reviewers have a separate design copy and they mark their comments over their individual copies. The main advantage of this method is that it is less time consuming, however the major drawback is that a single reviewer has to aggregate all comments of individual reviewers and generate a complete document. Furthermore, the method is not that much efficient as each reviewer cannot view the comments of all other reviewers thus defeating the purpose of the collaborative review system.

With the advancement of computer technology, collaborative design reviews have become easy, wherein computer aided techniques for example computer aided design (CAD), computer aided engineering (CAE), computer aided manufacturing (CAM) are well known computer based techniques for creating designs, technical documentation, building architectures, machineries, automobile designs, manufacturing processes, etc. The known computer aided techniques can create two-dimensional and/or three-dimensional designs of the objects. Also, some of these computer aided programs enables collaboration between the multiple users.

The most of the known and adapted solutions in the prior art proposes the aforementioned reviewing methods wherein designs can be reviewed by users either sequentially or concurrently, so these computers based design review methods are not that much successful and suffer the same drawbacks as that of the earlier paper based review techniques.

Furthermore, most of the computer aided designing techniques suffer a major drawback of being complex and limited interactive user inputs availability. The known computer aided designing techniques does not allow users to have dynamic design review and interactive simulation of the subject designs. Techniques are also known to render the 3D models of the 2D model of a model, however these techniques require a lot of user involvement and are time consuming. The automated methods to render the 3D model are not that much successful.

Also, these known designing and review techniques are very slow as users need to follow complex designing instructions, and these require a significant design expertise, so many stakeholders who want to contribute in the final completion of the design cannot provide their inputs due to lack of knowledge and expertise.

For the purpose of the collaborative design reviews, a simple technique is needed which would provide rich visual experience to the reviewers while editing the models, however unfortunately existing known techniques fail to meet these expectations.

Also, while 3D geometry is sufficient to communicate the data visually, the geometric model may not be able to perform simulations or analyze data if it is not enriched with additional information.

In another application area, the conventional systems of trailing are already well recognized e.g. pilot training program, repair & maintenance programs, vehicle/bike driving, aircraft simulation, mountain riding, fire training, emergency rescue operations, disaster management, sports, battlefield, surgery, etc. These training programs require a live or remote tutor/trainer who would transfer the knowledge and skillset to the trainee. However, it's extremely difficult and dangerous for a person to perform a particular task by only listening or reading the instructions given by the trainer. Certain environments require the involvement of the trainee in the task, and face the near to real world reality to execute the task with utmost quality. However, many of the tasks are extremely dangerous and life threatening, and therefore it may not be viable option to involve the trainee in the task before learning it, and therefore they mostly do not get the actual task sense.

Also, many simulation-based training techniques have been devised in the prior art, however these simulation models suffer from various disadvantages, namely known models are expensive, do not provide a realistic feel or responsiveness on the basis of user actions.

To date, these problems has not been solved by the existing solutions. Therefore, a need exists in the domain to provide an improved design review and an improved training based system and system to overcome the aforementioned shortcomings of the prior arts.

Applicant has devised, tested and embodied the present invention to address the aforementioned and other many problems of the already known prior art systems and devices.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

It is an object of the present invention to address the problems associated with the prior art techniques, and a novel system, apparatus, and a method for providing improved design reviews and user training. This technology opens the door to a range of new applications that have not been possible until now. The present invention revolutionizes training and design reviews with a radically new experience using Extended Reality.

It is an object of the present invention to facilitate Mixed Reality based trainings. A combination of software and specialized hardware is proposed in the present invention for experiential training and review using extended reality technologies namely Augmented Reality, Virtual Reality and Mixed Reality.

It is yet another object of the present invention to provide extended reality based wearable Head Mounting Device which provide users up to Six degrees of freedom.

It is another object of the present invention to provide real time recognition of what object user is looking at, wherein the objective is achieved by using a mixed reality based headset worn by the user along with the suitably trained artificial intelligence (AI) based Cognitive process automation program. The artificial intelligence (AI) based Cognitive process automation program uses camera feed from mixed reality headset (or alternatively virtual reality/augmented reality based headsets) and a combination of machine learning and artificial intelligence algorithms to automate routine and repetitive processes to cut down cycle time, reduce costs and improve customer satisfaction.

It is another object of the present invention to provide intelligent conversion of the 3D formats along with associated metadata into Extended Reality supported objects. According to an embodiment, the present invention is also configured to convert the two-dimensional models into Extended reality objects. Using the proposed technique work instructions are superimposed on the fly in the user's field-of-view which makes it easier for an employee to perceive a procedure of performing a certain task, thereby increasing the resource productivity.

It is another object of the present invention to implement safety training which is designed to reproduce practical scenarios in a virtual environment. Therefore, using the present invention we provide safe and effective guidance for situations that are too difficult, expensive, or dangerous to prepare for in the real world.

It is another object of the present invention to perform Artificial Intelligence based Cognitive process automation program which is configured to process the spatial data and map the processed special data to relevant three-dimensional models which are then superimposed on users view of real world.

It is yet another object of the preset invention to provide virtual reality based user training. According to this aspect of the present invention, Artificial Intelligence based Cognitive process automation program tracks every user action and activities inside training environment in real-time that's used for evaluation and results are produced on the basis of the recognized user action and activities. Also, the system for virtual reality based training supports the intelligent conversion of most of the three-dimensional formats along with metadata. Additionally, user's activities data and the associated results can be transferred to websites/mobile application in their respective readable formats for monitoring purposes.

It is yet another object of the present invention to cause virtual reality based design reviews. According to this aspect of the invention, complete design review cycle made easy and less time consuming using the innovative virtual reality based design review method proposed in the present invention.

The present invention uses a combination of artificial intelligence (AI) and extended reality based technologies with multiple applications ranging from design reviews and trainings. The design review feature of the present invention will enable customers to increase their productivity by reducing the design review time from months to hours.

According to this aspect of the invention, multiple users from remote locations can perform review at the same time in an immersive, interactive, and collaborative environment.

Also, all review data that consists of annotations, voice recording while reviewing and changes done by review team is collected and intelligently processed by Artificial Intelligence based Cognitive process automation program. This information is segregated into respective sections and is sent to the relevant design teams, which is further used to modify a subject design model, wherein the design model can be for example, and without limitation of an industrial environment, an asset, a building, a machine, a vehicle, construction site, warzone, an airplane, racing track, gaming environment, ship, or the like.

It is yet another object of the present invention to provide a Wireless extended reality based device (e.g. Virtual Reality (VR)/Augmented Reality (AR)/Mixed Reality (MR) based wearable device).

It is yet another object of the present invention to perform the trainings and the design reviews using virtual reality headsets with cellular communication capabilities, wherein the cellular communication can be such as, and without limitation, GSM, 2G, 3G, UMTS, EDGE, GPRS, 4G, LTE, and/or 5G communication techniques.

It is yet another object of the present invention to provide auto conversions of CAD\CAM models into equivalent and comparable extended reality (VR/AR/MR) based formats.

Various objects, features, aspects, and advantages of the present disclosure will become more apparent from the following detailed description of preferred embodiments, along with the accompanying drawing figures in which like numerals represent like features. The drawings illustrate exemplary embodiments of the present disclosure and, together with the description, serve to explain the principles of the present disclosure.

The foregoing summary is provided to introduce a selection of concepts in a simplified form that are further described below in the Detailed Description. This Summary is not intended to identify key features or essential features of the present invention, nor is it intended to be used to limit the scope of the subject matter.

### BRIEF DESCRIPTION OF DRAWINGS

The diagrams are for illustration only, which thus is not a limitation of the present disclosure, and wherein:

FIG. 1 illustrates a system 100 for the design review and analysis according to an exemplary embodiment of the present invention;

FIG. 2A is an exemplary block diagram of virtual/augmented/mixed reality engine and its various sub-components, according to an embodiment of the present invention;

FIG. 2B is an exemplary block diagram of virtual/augmented reality device and its various sub-components, according to an embodiment of the present invention;

FIG. 3 is an exemplary illustration of flow of data and functionality of various units of the virtual reality based design review system, according to another embodiment of the present invention;

FIG. 4 is an exemplary illustration of flow of data and functionality of various units of the augmented reality based design review and training system, according to another embodiment of the present invention; and

FIG. 5 is an exemplary illustration of flow of data and functionality of various units of the virtual reality based training system, according to another embodiment of the present invention;

### DETAILED DESCRIPTION OF DRAWINGS

Although the disclosure hereof is detailed and exact to enable those skilled in the art to practice the invention, the physical embodiments herein disclosed merely exemplify the invention which may be embodied in other specific structure.

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used in this application, the terms “system,” “platform,” “engine,” “controller,” “processor,” “processing unit,” “solution,” are intended to refer to a computer-related entity or an entity related to, or that is part of, an operational apparatus with one or more specific functionalities, wherein such entities can be either hardware, a combination of hardware and software, software, or software in execution. For example, an engine can be, but is not limited to being, a process running on a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be an engine. One or more instructions and/or computer program product can reside within a process and/or thread of execution, and an instructions and/or computer program product can be localized on one computer and/or distributed between two or more computers. As another example, an engine and/or platform can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As further yet another example, interface(s) can include input/output (I/O) components as well as associated processor, application, or Application Programming Interface (API) components.

Embodiments of the invention provide techniques for reviewing design of a computer designed model in a virtual environment, wherein the model includes design elements. For example, a target object and its elements, for example building, automobile, machine & its components, engine, etc. may be designed using the computer aided design technology in two-dimensional or three-dimensional format, and these designs may be reviewed in the virtual or augmented environment in the post-designing or pre-finalization phase to take inputs from one or more stakeholders. Therefore, using the present invention, the reviewers may not need to have high level knowledge to use the technology, and they can easily review the design and provide their inputs using input devices. Further, the present invention supports collaborative review and editing of the computer designs using the augmented reality/virtual reality technique, wherein each user may view the changes suggested by the other users in real-time.

According to an aspect of the present invention, each of the reviewer may separately choose which design elements to view in the virtual environment using a wearable device, and therefore the present invention may be suitable configured to hide different design elements (e.g. machine components) from the field of view of each reviewer according to their requirements and the input received from each reviewer. According to an embodiment, the information related to which design elements to display and/or hide is based the basis of the direction and/or location where the reviewer is looking.

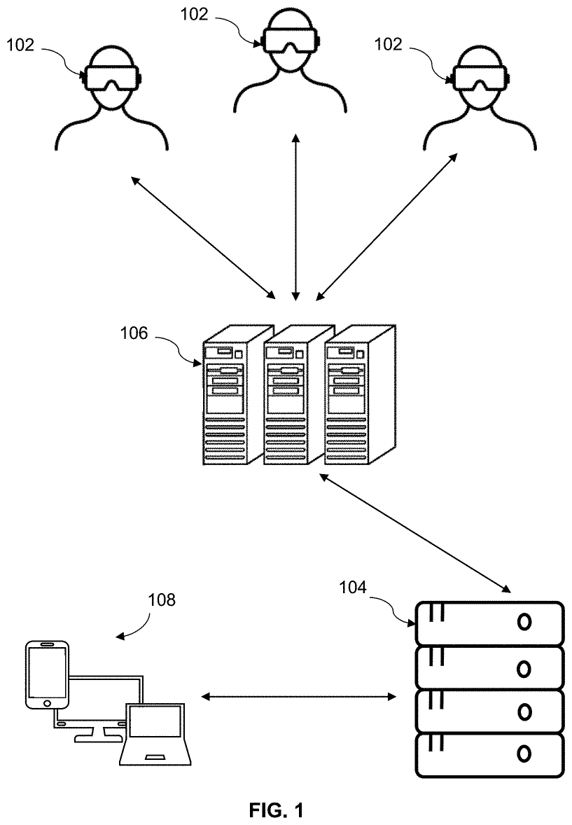

FIG. 1 illustrates a system 100 for the design review and analysis according to an exemplary embodiment of the present invention, wherein the design review and analysis system 100 comprises virtual/augmented reality devices 102, database 104, Virtual/augmented Reality engine 106, one or more end computers 108.

The database 104 is configured to store computer aided designs of the engineering processes, machines, buildings, machine components, industrial environment, etc. The computer aided designs are drawn using one or more end computers 108, and stored in the database 104. In an embodiment, the end computer 108 can be such as, and without limitation, personal computer, laptop, mobile, tablets, and the like which can run the computer aided design programs. The database 104 is also configured to store metadata related to the stored computer aided designs, wherein the metadata comprises information related to the object, for example, the metadata may include linking information between various design elements and components, color information, texture, depth, location coordinates, lighting, dimensions, etc.

In one embodiment of the invention, the database 104 is deployed at a local facility and is connected to one or more end computer 108 using a local area network (LAN) and/or intranet. In another embodiment of the invention, the database 104 is deployed at a remote location and thus may be accessed by the end computers 108 over a communication network (not shown). The communication network can be such as and without limitation, Internet, PSTN, Local Area Network (LAN), Wide Area Network (WAN), Metropolitan Area Network (MAN), LTE, cellular network, 5G, GSM, LTE, wi-fi, and so forth.

In an exemplary embodiment of the present invention, the end computers 108 are installed with a computer aided application (not shown). In an embodiment of the present invention, the computer aided application may be implemented as a software application (or combination of software and hardware). Further, the computer aided application running on the end computers 108 facilitate the user to draw the computer aided models (e.g. CAD/CAM), wherein the computer aided models can be two dimensional models and/or three-dimensional models. Each computer aided drawing (CAD design) may include multiple design elements associated with various components and parts of an object (e.g. real-world object).

Further, the CAD designs may also include one or more layers, wherein each layer comprises specific design elements. The layering assists the user in organising data within the drawing, and makes it easier to fetch the object information embedded within CAD design. For example, various features of the object can be drawn on different layers.

The Virtual/Augmented Reality engine 106 is a suitably programmed computer system implemented as a combination of software and hardware components, wherein the virtual/augmented reality engine 106 is programmed to cause the generation of the virtual/augmented reality elements from a CAD model of an object and its associated metadata, wherein the CAD model and its associated metadata is retrieved from the database 104 over the communication network, wherein the communication network can be, such as but not limited to, Internet, PSTN, Local Area Network (LAN), Wide Area Network (WAN), Metropolitan Area Network (MAN), LTE, cellular network, LTE, GPRS, 5G, wi-fi, and so forth.

The corresponding virtual/augmented reality elements generated by the Virtual/augmented Reality engine 106 by processing the CAD model of the object and its associated metadata and is provided to the virtual/augmented reality (VR) devices 102.

In an embodiment, VR devices 102 are user wearable devices, and provide real world visualisation of the object drawn in the CAD model. In accordance with another embodiment of the invention, the virtual/augmented reality engine 106 may generate and provide a graphical user interface for enabling the user interaction with the virtual/augmented environment displaying the virtual/augmented model of the object. By using the graphical user interface the user may interact with the virtual/augmented object and its components, and provide inputs related to design reviews and updation.

According to an embodiment, the virtual/augmented reality engine 106 may be integrated in a housing of the VR devices 102. According to another embodiment, the virtual/augmented reality engine 106 is a standalone device which is configured to function in coordination with other devices.

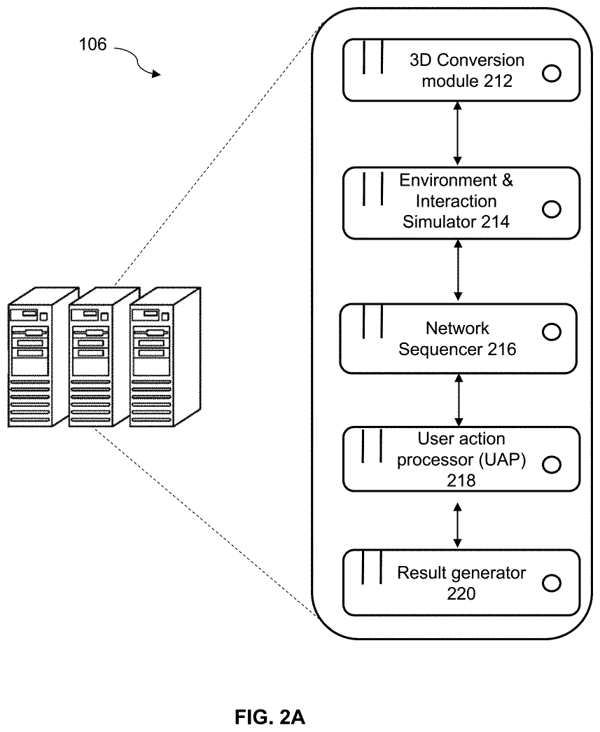

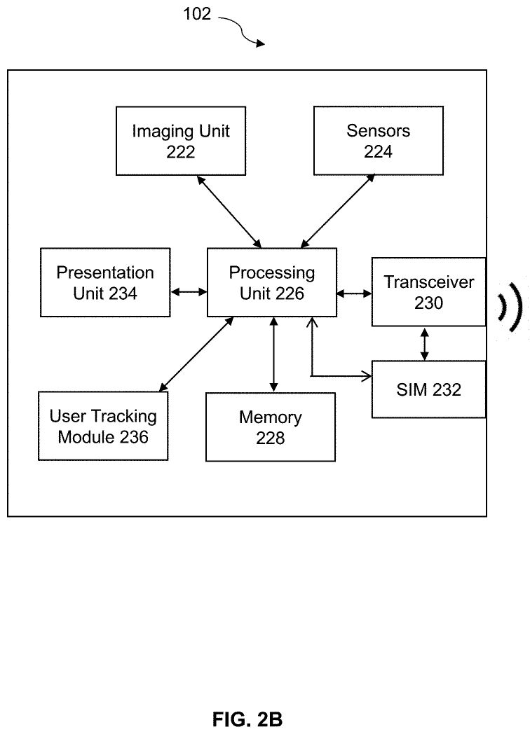

According to one embodiment of the present invention, the VR design elements of the equivalent CAD model generated by the VR engine 106 are transmitted and provided to the VR devices 102 by using cellular communication (e.g. 2G, 3G, UMTS, LTE, EDGE, 5D, and the like). According to another embodiment, the VR design elements of the equivalent CAD model generated by the VR engine 106 are transmitted and provided to the VR devices 102 by using Wi-Fi network. According to another embodiment, the VR design elements of the equivalent CAD model generated by the VR engine 106 are transmitted and provided to the VR devices 102 by using communication network comprising one or more of LAN, WAN, MAN, Cellular network, 5G, LTE, internet, and the like. Various sub-components, sub-systems, and/or sub-units of the VR engine 106 and VR devices 102 are covered in FIG. 2 in the foregoing specifications.

In an embodiment, the virtual/augmented reality devices 102 may be configured to overlay the generated virtual/augmented reality representation on the corresponding real-world object by using the metadata information. For example, the metadata information may be related to location coordinates of the real-world objects, and when the user wearing the virtual/augmented reality device 102 looks at the real-world object (physical objects), it overlays the corresponding virtual/augmented representation generated by the VR engine 106 over the associated real-world object. Further, the metadata information may include color, background color, text, font style & sizes, menu, icons, depth, dimensions, size, shape, or the like of the virtual/augmented reality objects and/or environment.

According to another aspect of the present invention, object recognition functionalities are provided, wherein the virtual/augmented reality device is configured to capture objects in the field of view of the user, and streams the captured images in real-time to the virtual/augmented reality engine 106. Then, the virtual/augmented reality engine 106 processes the images received from the devices 102, and identifies the objects in the field of view, wherein the objects are recognised by the image processing functionality. According to yet another embodiment, the object may be recognised by searching in the database 104, for example, the virtual/augmented reality engine 106 may identify features of the object, and search those in the metadata information stored in the database 104 to identify the matching objects and their associated CAD models.

In one example, the object recognition functionality may be programmed within the virtual/augmented-reality device 102.

In one embodiment, the CAD models may not require to be pre-stored in the database 104 and may be generated in real-time by the virtual/augmented reality engine 106 by scanning the field of view of the user by using the virtual/augmented reality devices 102.

In one exemplary embodiment, the objects in the field of view of the user wearing the virtual/augmented reality device 102 are detected by the virtual/augmented reality engine, and the corresponding CAD model of the one or more object is retrieved from the database 104, which is then used by the virtual/augmented reality engine to generate the virtual/augmented reality elements of the object on the basis of the retrieved CAD model. The virtual/augmented reality engine is configured to provide the generated virtual/augmented reality elements to the virtual/augmented reality device 102 along with the graphical user interface to interact with the virtual/augmented reality design elements of the CAD model.

The virtual/augmented reality engine 106 is further programmed detect one or more of user interactions with the virtual/augmented reality based object by using the graphical user interface, and/or location or direction of the user's eye to retrieve another CAD model of the sub-part of the object. On the basis of the detection, the virtual/augmented reality engine may perform various actions, for example and without limitation, the virtual/augmented reality engine 106 may generate the corresponding virtual/augmented reality representation of the sub-part and provide the same to the virtual/augmented reality device 102 for display to the user in real-time. Therefore, the user may interact with the virtual/augmented reality representation of the target object, for example, user may zoom-in/zoom-out the object, rotate the object, view the object from various angles (top, bottom, etc.), change colours, texture, shape, dimensions, size, dismantle the object, or the like as per the requirements. The virtual/augmented reality engine 106 is further designed to receive inputs from the user, wherein the inputs may be related to changes to be made in the CAD model. Thereafter, the virtual/augmented reality engine 106 may be configured to facilitate the review and the updation of the corresponding CAD model as per the inputs received by the user on the basis of the user interaction with the virtual/augmented representation of the CAD model. In an embodiment, multiple users may use the virtual/augmented reality devices 106 and provide their inputs related to changes in the CAD model by interacting with the virtual/augmented representation of the CAD model by using the graphical user interface in the virtual/augmented reality environment. Thus, users do not require to have high-level knowledge of the complex designing module to contribute in the design review and design finalization.

Referring to FIG. 2A where the various sub-modules of the virtual/augmented reality engine 106 are displayed. As illustrated, the virtual/augmented reality engine 106 comprises 3D conversion module 212, Environment and interaction simulator 214, Network Sequencer 216, User Action processor (UAP) 218, and/or Result generator 220. These various sub-modules of the virtual/augmented reality engine 106 may be implemented as software components, hardware components, and combination thereof.

The 3D conversion module 212 processes the CAD models and thereafter converts multiple 3D formats and attaches its metadata in virtual/augmented reality compatible format.

The Environment and interaction simulator 214 processes the virtual/augmented-reality ready 3D models and adds the interactive graphical user interface (e.g. menus, icons). In an embodiment, the interactive user interface provided by the Environment and interaction simulator 214 is dynamic and adaptive as per the immersive environment representing the CAD model in the virtual/augmented reality.

The Network Sequencer 216 is configured to maintain coordination between data received from the multiple users, wherein the Network Sequencer 216 sets up connection between multiple users and synchronizes actions between them with minimum latency. In an embodiment, the Network Sequencer 216 maintains a table storing a sequence of actions given by multiple users translating to the changes to be made in the CAD design.

The User Action processor (UAP) 218 is artificial intelligence and machine learning based module which processes the user actions, and deduce the corresponding related output. The User Action processor (UAP) 218 intelligently processes the combination of user actions, for example, tracking movement and location of the user's eye to provide information about user's action in immersive virtual/augmented reality environment. In an embodiment, the user's body language, voice, hand gestures, or other similar body languages may be tracked to identify the type of the user's action in the immersive virtual/augmented reality environment. In an embodiment, the User Action processor (UAP) 218 may be configured to retrieve information regarding user's action from one or more body mounted sensors, one or more cameras, etc. In an embodiment, the cameras may be mounted on the virtual/augmented reality device 102 towards the body of the user (e.g. inward mounted camera towards the eyes of the user).

The result generator 220 is programmed to generate usable & transferrable results that could be a 3D model, a Json/XML file or the like that can be consumed by external resources.

As shown in FIG. 2B, the virtual/augmented reality devices 102 comprises one or more imaging units 222, wherein the imaging unit is configured to capture pictures (e.g. visual feed) of various objects of interest. In an embodiment, the objects of interest are identified by the virtual/augmented reality device 102 the help of virtual/augmented reality engine 106. In another embodiment, the virtual/augmented reality device 102 is programmed to automatically identify the objects of interests using suitably designed artificial intelligence & machine learning techniques. In an embodiment, the virtual/augmented reality device 102 further comprises one or more sensors 224 to acquire one or more parameters of interest. For example, the sensors 224 can be temperature sensors, infrared (IR) sensors, humidity sensor, IR camera, seismic sensors, radiation detectors, ultrasound telemetary sensors, thermal sensors, motion sensor, accelerometer vibration sensor, optical sensor, photosensitive sensor, chemical sensors, speedometer, pressure sensor, altimeter, Radar, Lidar, etc. These sensors 224 are configured to detect parameters such as, but not limited to, environmental conditions, vibrations, ambient temperature, motion, heat, body temperature, hand gestures, user motion, and so forth.

The virtual/augmented reality device 102 further comprises a processing unit 226 which may be suitably designed and configured to facilitate the execution of various functions as per one or more instructions programmed in a memory 228 of the virtual/augmented reality device 102 which are executed by the processing unit 226.

The processing unit 226 of the virtual/augmented reality device 102 may be configured to receive data from various sensors 224 and/or imaging unit to enable interactions with the virtual/augmented reality representation of the CAD model, wherein the user may perform the analysis and review of the CAD model using the virtual/augmented reality environment.

In an embodiment, the virtual/augmented reality device 102 comprises long-distance wireless communication capabilities, wherein the long-distance wireless communication capabilities include wi-fi, cellular communication, etc. The virtual/augmented reality device 102 may also include a subscriber identity module (SIM) 232, for example, E-SIM or regular-SIM, to enable the long-distance wireless communication capabilities.

Further, virtual/augmented reality device 102 is provided with wireless communication capabilities, wherein the virtual/augmented reality device 102 comprises a transceiver 230 to communicate with one or more devices using the communication network, wherein the one or more devices can be, for example and without limitation, virtual/augmented reality engine 106, one or more end computers 108, other virtual/augmented reality devices 102, and/or database 104.

Furthermore, virtual/augmented reality device 102 also comprises a presentation unit/reconstruction unit 234, which is configured to display and present the virtual/augmented reality objects in the virtual/augmented reality environment on the basis of the information received from the virtual/augmented reality engine. For example, the information is related to the reconstruction or presentation of the virtual/augmented reality objects and/or environment, and can be such as, and without limitation, virtual/augmented reality color information, text data, background information, and/or information related to the area/region and/or identity of the object where the virtual/augmented reality objects are to be presented.

Also, the virtual/augmented reality device 102 comprises a user tracking module 236, which is configured to track user's performance and activities while wearing the device 102. For example, the user tracking module 236 may be configured to process data received from various sensors 224 and imaging units 222, and identify such as, and without limitations, user interactions with virtual/augmented objects, areas of user's interest, user gaze, how many clicks made by the user, etc.

The data recorded by the virtual/augmented reality device 102 may be transmitted in real-time to one or more devices over the communication network using the long-distance wireless communication capabilities.

In an embodiment, the virtual/augmented reality device 102 is configured to capture audio, video, images, and/or other sensor capture data, the captured data is streamed in real-time to the virtual/augmented reality engine 106.

In another embodiment, the data recorded by the virtual/augmented reality device 102 is transmitted in real-time to the virtual/augmented reality engine 106, wherein the received data is processed and rendered into 3D models by using high computing power distributed and parallel processing using a plurality of CPUs and/or GPUs. The virtual/augmented reality engine 106 is suitably designed and configured to receive the data from one or more virtual/augmented reality device 102, and render the received data into 3D models and/or virtual/augmented reality objects using high speed distributed and parallel processing.

According to an embodiment, the plurality of virtual/augmented reality devices 102 are configured to operate in collaboration. According to this embodiment, the information received from the plurality of virtual/augmented reality devices 102 is processed and stitched together by the virtual/augmented reality engine 106, and a consolidated design review and updation instructions are generated by the virtual/augmented reality engine 106 for updating the subject CAD model.

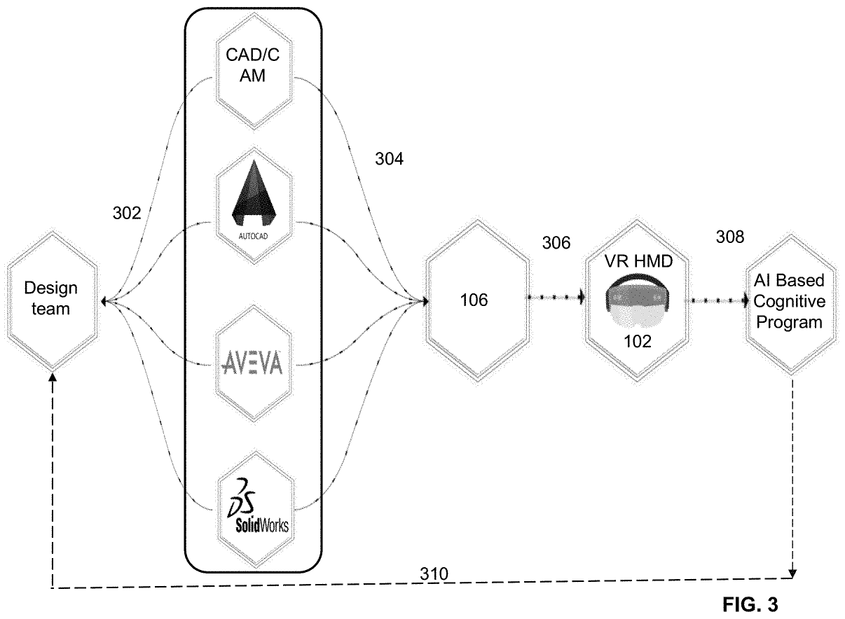

Accordingly, in FIG. 3, flow of data and functionality of various units of the virtual reality based design review system are disclosed. As illustrated, in step 302, design team designs and stores computer aided designs and its associated metadata in the database 104, wherein the computer aided design may be drawn over a plurality of application programs (e.g. CAD/CAM, AutoCAD, Aveva, solidworks, and the like) running on the end computers 108.

The computer aided designs stored in the database 104 may be retrieved by one or more reviewers, and thereby are provided to the virtual reality engine 106, wherein the virtual reality engine 106 consolidates the artificial intelligence and the machine learning functionalities, and processes the retrieved subject computer aided models, and generates a corresponding virtual reality representation of the computer aided model (e.g. CAD model), in step 304.

In step 306, the generated virtual reality representation is thereby provided to one or more reviewers wearing the virtual reality devices 102. In an embodiment, the reviewers may be working together from various remote locations. The virtual reality engine 106 also provides the user interface to enable the reviewer to interact with the virtual reality based representation of the CAD model. The virtual reality based device is configured to track/record reviewer actions related to the changes and updations to be made in the CAD model. For example, reviewers may give recommendation on what design elements are to be changed, what design elements need review, etc. Thus, the multiple participants may work collaboratively and modify the design model in real-time by simultaneously considering each other's suggestions.

The various design modifications are received from the plurality of virtual reality devices 102 by a suitably trained artificial intelligence (AI) based cognitive process automation program module which is configured to capture/track every user action and activities inside virtual environment in real-time and results related to design changes are produced on the basis of the recognized user action and activities, shown in step 308. In an embodiment, the artificial intelligence (AI) based cognitive process automation program module may be implemented within the virtual reality engine 102. In another embodiment, the artificial intelligence (AI) based cognitive process automation program module may be deployed using a separate computing infrastructure. The artificial intelligence (AI) based cognitive process automation program module uses historical user data and various corresponding results collected over time to process and make intelligent decisions.

In an embodiment, artificial intelligence (AI) based Cognitive process automation program may be deployed and part of the virtual/augmented reality engine 106. In another embodiment, the artificial intelligence (AI) based Cognitive process automation program may be deployed over a separate computing infrastructure. In another embodiment, the artificial intelligence (AI) based cognitive process automation program module may be deployed over cloud based infrastructure. In an embodiment, the artificial intelligence (AI) based cognitive process automation program module may be implemented using suitably programmed hardware and/or software instructions.

In step 310, the output produced by the artificial intelligence (AI) based Cognitive process automation program is thereby transmitted to the designing team for implementing the changes, wherein the design team may map the received feedback from multiple users in the existing design model to generate the updated version. In an embodiment, the consolidated changes suggested by one or more users are provided by the artificial intelligence (AI) based Cognitive process automation program to the virtual reality engine 106 which may be suitable programmed to automatically facilitate the updation of the associated CAD model and its metadata without any user-interventions.

Thereby, the present invention facilitates the design review and modifications by enabling real-time collaboration between the remote users by consolidating feedback given by multiple remote users.

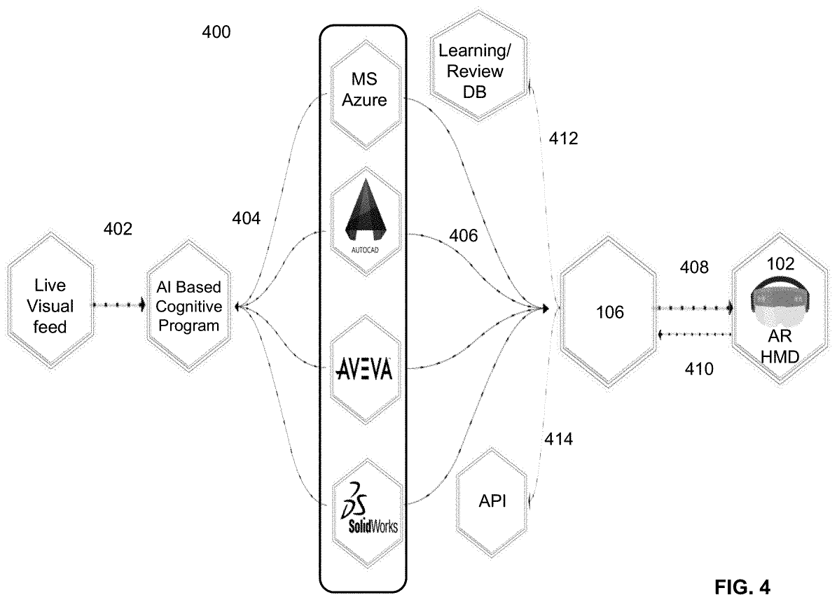

Referring to FIG. 4 now, wherein flow of data and functionality of various units of the augmented reality based design review and training system are disclosed. The augmented reality based process 400 starts at step 402, wherein live visual feed of a scene is received by the suitable trained artificial intelligence (AI) based Cognitive process automation program module. The artificial intelligence (AI) based Cognitive process automation program is configured to identify the various objects in the scene.

For example, one or more users (e.g. reviewers) wearing the augmented reality devices 102 having imaging units 222 may capture the live visual feed and provide it to the artificial intelligence (AI) based Cognitive process automation program. In an embodiment, artificial intelligence (AI) based Cognitive process automation program may be deployed and part of the virtual/augmented reality engine 106. In another embodiment, the artificial intelligence (AI) based Cognitive process automation program may be deployed over a separate computing infrastructure. In another embodiment, the artificial intelligence (AI) based Cognitive process automation program may be deployed over cloud based infrastructure.

In step 404, the artificial intelligence (AI) based Cognitive process automation program is configured to analyze what the user is currently looking at and sends the relevant information to the augmented reality engine 106. For example is artificial intelligence (AI) based Cognitive process automation program is configured to query the database 104 and retrieve the computer aided design of at least an object in the field of view of at least one user wearing the augmented reality device 102, and in step 406, the retrieved computer aided design (e.g. AUTOCAD, Solidworks) is provided to the augmented reality engine 106. In an embodiment, the AI based Cognitive process automation program is suitable programmed with image processing capabilities to recognize the various objects in the live visual stream. Thereby, the artificial Intelligence based Cognitive process automation program which is configured to process the spatial data and map the processed special data to relevant three-dimensional models which are then superimposed on users view of real world.

In step 408, the augmented reality engine 106 generates the augmented reality based representation corresponding to the computer aided design retrieved in the previous step. The augmented reality engine 106 also decides what to display and what not to display. The augmented reality based representation is generated by the augmented reality engine 106 by processing the metadata associated with the computer aided design. The augmented reality engine may also receive additional information as an input, for example, training information, learning information, or user specific customization information to adapt the AR based environment using a knowledge/learning database. For example, the additional information may be provided according to requirements of a user to customize the augmented reality environment according to user's needs. Additionally, the augmented reality engine is programmed to interface with application program interface (APIs) to receive supplementary information from third party sources using the application program interface, wherein the received supplementary information is used to create the augmented reality environment. For example, the additional information and/or the supplementary information may be used to decide what information to display and what not to display in the virtual reality environment.

In step 410, the generated augmented reality based representation is transferred to the one or more augmented reality devices 102 along with metadata comprising augmentation properties (e.g. color, background color, text, menu, icons, depth, dimensions, size, shape, etc.) and/or location of the object in real-world over which the virtual representation is to be overlaid.

In step 410, the various activities performed by the one or more users wearing the augmented reality devices 102 are tracked by the augmented reality engine 106 in real-time. For example, the location of the user's eye may be tracked or hand gestures of the user may be tracked by the augmented reality engine 106 to determine the output related to state changes of the augmented reality environment or the various changes that are to be made in the computer aided design.

In step 412, once the augmented reality engine 106 has determined what kind of user actions has been performed and the corresponding output, the resulting information is transferred to the learning/review database for making the changes in the design. Also, in step 414, the output identified by the augmented reality engine 106 on the basis of user inputs is transferred to various application program interface (APIs) for further analysis and/or monitoring purposes.

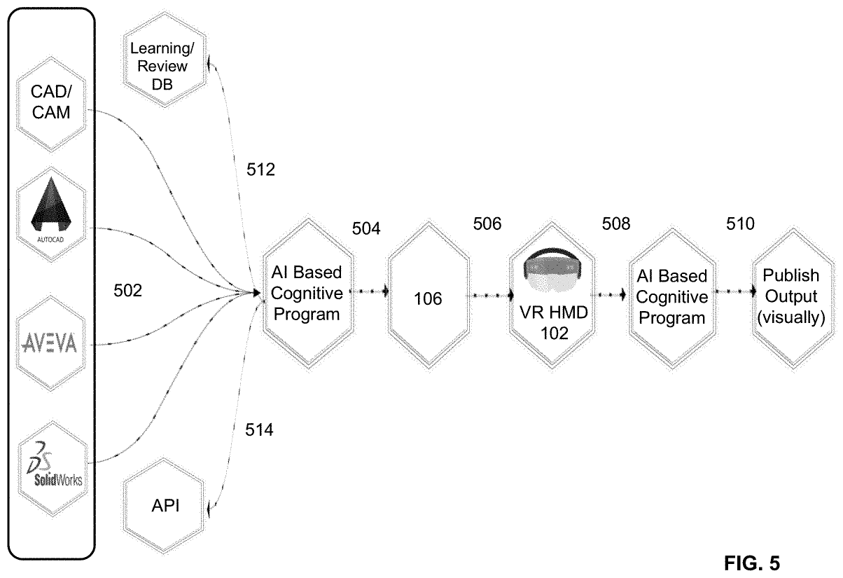

Referring to FIG. 5, wherein flow of data and functionality of various units of the virtual reality based training system is disclosed. The process starts at step 502, wherein virtual design model & its corresponding metadata of a simulating environment (virtual reality environment) is received by the AI based cognitive process automation program which processes the received metadata and computed aided design model and transfers the resultant output to the virtual reality engine 106, as shown in step 504. The Artificial Intelligence based Cognitive process automation program which is configured to process the spatial data and map the processed special data to relevant three-dimensional models which are then used to facilitate the generation of the virtual reality environment.

The AI based cognitive process automation program also receives additional information as an input, for example, training information, learning information, or review information to adapt the virtual design model from a knowledge database, as shown in step 512. For example, the additional information may be provided according to requirements of a user to customize the virtual reality environment according to user's needs. Additionally, the AI based cognitive process automation program is programmed to interface with application program interface (APIs) to receive supplementary information from third party sources using the application program interface, wherein the received supplementary information is used to create the virtual reality environment, as shown in step 514. For example, the additional information and/or the supplementary information may be used to decide what information to display and what not to display in the virtual reality environment.

In step 506, the VR engine 106 generates corresponding virtual reality based representation by deciding what objects to display and what not to display by processing the received input information from various sources, and provides the generated virtual reality based representation to the virtual reality device/headset 102.

The virtual reality headset 102 displays the virtual reality environment to one or more users wearing the headsets. The virtual reality engine is also configured to track user interactions in the virtual environment and is configured to provide this information to the AI based cognitive program, as shown in step 508. For example, the virtual reality headset is suitably designed and programmed to track eyes of the user wearing the headset to determine user's interactions with the virtual reality objects in the virtual reality environment. The virtual reality headset is also designed to enable the user to interact with the virtual reality environment, and user's actions & activity data are processed by the virtual reality headset to facilitate modification of the one or more virtual reality objects in accordance to user's actions. Therefore, the virtual reality headset 102 provides users up to Six degrees of freedom.

In next step 510, the AI based cognitive program intelligently processes the received user actions and activity data, and produces results based on user's performances inside virtual reality environment. For example, the AI based cognitive program intelligently track and provide information on how much time user has spent inside VR, where was their focus, where they need to focus, etc. The AI based Cognitive process automation program tracks every user action and activities inside virtual reality based training environment in real-time that's used for evaluation and results are produced on the basis of the recognized user action and activities. Also, the system for virtual reality based training supports the intelligent conversion of most of the three-dimensional formats along with metadata.

The results of the user's performance as determined by the AI based cognitive program are then published on a dashboard (e.g. website, performance tracking dashboard, etc.) to track user's performance in the virtual reality environment, as shown in step 512. For example, the output generated by the AI based cognitive program in step 510 may be used to identify performance improvement plan for each user individually. In effect, user's activities data and the associated results can be transferred to websites/mobile application in their respective readable formats for monitoring and assessment purposes. Accordingly, the present invention facilitates the assessment of user's performance in the virtual reality environment to assist in planning a tailored user performance improvement plan.

Therefore, the present invention provides a unique and novel technique to provide real-time collaborative design reviews and trainings. The user may not need to have real equipments and resources for performing a certain activity.

While the disclosed embodiments of the subject matter described herein have been shown in the drawing and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A method comprising:
converting, by a 3D conversion module, a three-dimensional model into a compatible virtual reality or augmented reality format, by using a metadata information;
adding, by an environment & interaction simulator, one or more interactive graphical user interfaces into the converted compatible virtual reality or augmented reality format;
setting up connection between multiple user by using a network sequencer to synchronize actions between them with minimum latency;
processing, by user action processor (UAP), interactions of one or more users with the virtual reality or augmented reality format by tracking user actions; and
generating, by a result generator, an output on the basis of the tracked user actions.

2. The method of claim 1, wherein the generated output is used to modify design of the three-dimensional model according to the tracked user actions.

3. The method of claim 1, wherein the generated output facilitates real-time tracking of performance of the one or more users.

4. The method of claim 1, wherein the user action processor (UAP) is based on artificial intelligence and/or machine learning techniques.

5. The method of claim 1, wherein the metadata information further comprises one or more of a color, text, font style, menu, icons, depth, dimensions, size, and shape of one or more virtual/augmented reality objects.

6. The method of claim 1 further comprises:
providing the virtual reality or augmented reality format to the one or more users by using a virtual reality head mounted display or an augmented reality head mounted display.

7. The method of claim 6, wherein the virtual reality head mounted display or augmented reality head mounted display is further provided with wireless communication capability, wherein the wireless communication capability comprises one or more of GSM, GPRS, 5G, 4G, 3G, 2G, WI-FI, and WLAN.

8. A method comprising:
receiving, by a virtual reality engine from a design database, one or more three-dimensional models corresponding to a virtual reality environment along with associated metadata;
processing, by the virtual reality engine, the received one or more three-dimensional models and the metadata to generate a corresponding virtual reality environment, wherein the virtual reality environment generated by the virtual reality engine comprises one or more virtual reality objects and/or VR based graphical user interfaces;
providing the generated virtual reality representation to the one or more users, wherein each user is wearing a virtual reality headset;
tracking, by the virtual reality headset, user interactions within the virtual reality environment;
providing, by the virtual reality headset, information related to the tracked user interactions within the virtual reality environment to an artificial intelligence (AI) based cognitive program module; and
processing, by the artificial intelligence (AI) based cognitive program module, the received information related to the tracked user interactions of the one or more users to determine one or more design changes, wherein the determined design changes facilitate updation of the one or more three-dimensional models.

9. A method comprising:
receiving, by an artificial intelligence (AI) based cognitive program module, a real-time visual stream of a real-world environment;
processing, by the artificial intelligence (AI) based cognitive program module, the received real-time visual stream to identify one or more real-world objects;
retrieving, by the artificial intelligence (AI) based cognitive program module, one or more three-dimensional models and associated corresponding to the identified one or more real-world objects;
receiving, by an augmented reality engine, the retrieved one or more three-dimensional models and the metadata;
generating, by the augmented reality engine, an augmented reality based representation corresponding to the received one or more three-dimensional models by processing the metadata;
providing, by the augmented reality engine, the generated augmented reality based representation along with augmentation properties to one or more users by using their augmented reality headsets;
superimposing, by the augmented reality headset, the augmented reality based representation over the corresponding one or more real-world objects by processing the received augmentation properties;
tracking, by using the augmented reality headset, user actions of one or more users, wherein the tracking of user actions comprises eye tracking and/or hand tracking.
generating an output on the basis of the tracked user actions, wherein the generated output is used to modify design of the one or more three-dimensional models according to the tracked user actions and/or to facilitate real-time tracking of performance of the one or more users.

10. A method comprising:
receiving and processing, by an artificial intelligence (AI) based cognitive program module, one or more three-dimensional models and associated metadata corresponding to one or more real-world objects;
providing, by the artificial intelligence (AI) based cognitive program module, the processed three-dimensional models and associated metadata to a virtual reality engine;
generating, by the virtual reality engine, a corresponding virtual reality environment by processing the three-dimensional models and the associated metadata information provided by the artificial intelligence (AI) based cognitive program module;
transmitting, by the virtual reality engine, the information to display the virtual reality environment to one or more virtual reality devices;
displaying, by the one or more virtual reality devices, the virtual reality environment by using the information transmitted by the virtual reality engine;
tracking, by the one or more virtual reality devices, user actions of one or more users, wherein the tracking of user actions comprises eye tracking and/or hand tracking;
receiving, by the artificial intelligence (AI) based cognitive program module, tracked user actions of the one or more users; and
generating an output, by the artificial intelligence (AI) based cognitive program module, on the basis of the tracked user actions, wherein the output is related to real-time performance of the one or more users.
